(19) United States
(12) Patent Application Publication
(10) Pub. No.: US 2002/0126069 A1
(43) Pub. Date: Sep. 12, 2002

(54) AC surface discharge plasma display panel and method for driving the same

(75) Inventors: Bong Chool Kim, Kumi-si (KR); Beom Gu Kang, Seoul (KR); Gyun Chae, Kunpo-si (KR)

Correspondence Address: BRUCE E. LILLING, LILLING & LILLING P.C., P.O. BOX 560, GOLDEN BRIDGE, NY, 10526, US

(73) Assignee: UPD Corporation, Icheon-si (KR)

(21) Appl. No.: 10/042,803

(22) Filed: Jan. 9, 2002

(30) Foreign Application Priority Data
Mar. 8, 2001 (KR) 2001-11902

(51) Int. Cl. G09G 3/28

(52) U.S. Cl. 345/60

(57) ABSTRACT

There is provided a method for driving an AC surface discharge PDP which includes a plurality of scan electrodes driven, being divided into upper and lower groups, a plurality of sustain electrodes respectively corresponding to the scan electrodes and being arranged on the same plane in parallel with the scan electrodes and a plurality of first and second address electrodes being divided into upper and lower parts and intersecting the scan electrodes and the sustain electrodes having predetermined spaces therebetween, the PDP having a discharge cell formed at an intersection where the scan electrodes and sustain electrodes intersect the first and second address electrodes. In the event of scanning the scan electrodes of the upper groups placed in the area where the first address electrodes are arranged and the scan electrodes of the lower groups located in the area where the second address electrodes are arranged, predetermined scanning pulses are sequentially applied to the scan electrodes of the upper and lower groups, respectively, and simultaneously, a predetermined image pulse is selectively applied to the first and second address electrodes with the same clock as the scanning pulses, the scanning pulse being applied to the lower scan electrodes in advance by at least one clock before the scanning pulse is applied to the upper scan electrodes.

### BACKGROUND OF THE INVENTION

1. Field of the Invention The present invention generally relates to a plasma display panel (PDP) and a method for driving the same and, more particularly, to an AC surface discharge PDP and a method for driving the same, which drives address electrodes of the PDP, dividing them into upper and lower groups, to thereby improve picture quality of display images.

2. Description of the Related Art

A plasma display panel (referred to as ‘PDP’ hereinafter) is a light-emitting device that excites a fluorescent materials placed in discharge cells thereof to display images. It is compact, manufactured through simple fabrication processes and easily realized in a large screen so that it is widely used as a bulletin board of a stock exchange, a display for video conferencing and a wide-screen wall-hanged TV.

The PDP is classified into AC and DC types based on its driving voltage form. In case of the AC surface discharge PDP, an addressing display separated (ADS) method is mainly employed which drives frames, dividing one frame into a plurality of sub-fields according to gray levels. Each sub-field is classified into a reset period, an address period and a sustain period, and one frame is constructed of eight sub-fields to realize 256 gray levels, as well known in the art.

FIG. 1 is a block diagram that roughly shows a conventional AC surface discharge PDP driven by the ADS method. In FIG. 1, reference numeral 10 denotes the panel of the PDP constructed in such a manner that M scan electrodes Y₁-Y_{M} and sustain electrodes X₁-X_{M} are arranged in parallel and N address electrodes A₁-A_{M} are arranged orthogonal to the scan electrodes and sustain electrodes, having a predetermined space between them.

A discharge cell S divided into R (Red), G (Green) and B (Blue) cells is formed at each intersection where the scan electrodes, sustain electrodes and address electrodes cross. The discharge cells display images with MxN resolution in a matrix form. The inner structure of the discharge cell S is well known in the art so that explanation therefor is omitted.

In FIG. 1, reference numeral 20 denotes a scan electrode driver which has a plurality of output ports serially one-to-one connected with the scan electrodes Y₁-Y_{M} and provides a driving pulse to the scan electrodes. Reference numeral 30 represents a sustain electrode driver connected to the sustain electrodes X₁-X_{M} through one common sustain electrode X′, and 40 denotes an address electrode driver serially connected with the address electrodes A₁-A_{M} one to one and provides a driving pulse to the address electrodes A₁-A_{M}. In addition, reference numeral 50 represents a controller which converts an analog video signal IMAGE externally applied into a digital video signal, and controls the operations of the scan electrode driver 20, sustain electrode driver 30 and address electrode driver 40 to adjust output of the digital video signal based on a clock signal (CLK), a horizontal synchronous signal HS and a vertical synchronous signal VS which are external input signals.

A method of driving the conventional AC PDP constructed as above is described below with reference to FIG. 2. FIG. 2 is a timing diagram for explaining the method of driving the conventional AC PDP. For displaying 256 gray scales, one frame of a display image is driven, being divided into eight sub-fields, and each sub-field is classified into the reset period A, address period B and sustain period C. FIG. 2 shows the timing chart with respect to one sub-field SF1.

Referring to FIG. 2, the reset period A is for generating wall charges in the discharge cell S and increasing a response speed of continuous addressing discharge. During this reset period, a writing pulse 21 whose level is higher than a discharge initiating voltage is supplied to the common sustain electrode X′ to add up voltages of generated wall charges, and then an erasing pulse 22 of 0V is provided to all the scan electrodes Y₁-Y_{M} while a voltage Vs lower than the discharge initiating voltage is being applied through the common sustain electrode X′, to erase unnecessary wall charges in the discharge cell S.

The address period B is for addressing a corresponding digital video signal into each discharge cell S. During this address period B, a scanning pulse 23 is sequentially applied to the scan electrodes Y₁-Y_{M} and an image pulse 24 is provided to corresponding address electrodes Aₗ-A_{M}. Accordingly, addressing discharge is created between the scan electrodes Y₁-Y_{M} and address electrodes A₁-A_{M} of corresponding discharge cell S and wall charges for sustain discharge are generated.

During the sustain period C, sustaining pulses 25 and 26 are alternately applied to the common sustain electrode X′ and the scan electrodes to control the number of times of discharging for a unit time with respect to the discharge cell S in which the wall charges are created during the address period B. By doing so, luminance of each sub-field is raised and raised luminance of the entire sub-fields are combined to display gray levels. Here, the reset period A and address period B have the same span of time for every sub-field, and the span of time corresponding to the sustain period C is different for sub-fields according to the number of times of discharging per a unit time of corresponding discharge cell S, that is, brightness.

However, the percentage occupied by the address period B in the driving time of one frame increases as the resolution of display image is improved and the percentage of the sustain period C affecting the brightness of display image decreases. Thus, it is difficult to realize high resolution of above 256 gray levels. Furthermore, high current of above 100A flows alternately in the PDP in case of sustain discharge of the panel 10 so that expensive devices are used with regard to rated values of circuit devices in the PDP, increasing production costs.

Accordingly, Korean patent opened publication No. 99-23086 discloses a PDP driving method in which address electrodes A_{D1}˜A_{DN} and A_{d1}˜A_{dN} divided into upper and lower parts, as shown in FIG. 3, scan electrodes Y₁˜A_{M/2} and Y_{M/2+1}˜Y_{M} corresponding to the upper and lower parts are simultaneously scanned sequentially, and then sustain discharge is alternately performed between the scan electrodes Y₁˜A_{M/2} and Y_{M/2+1}˜Y_{M} and sustain electrodes X₁˜X_{M/2} and X_{M/2+1}˜X_{M}, to thereby reduce the span of time for the address period B by half while maintaining the brightness of a display image. That is, FIG. 3 illustrates the configuration of the conventional AC surface discharge PDP whose address electrodes are divided into upper and lower parts. In this configuration, the span of time corresponding to the sustain period C increases as the address period B is reduced so that the brightness of the display image can be improved.

However, in case of the aforementioned technique, division of the address electrodes A_{D1}˜A_{DN} and A_{d1}˜A_{dN} of the panel into upper and lower parts requires high precision when front and back plates of the panel are combined with each other. Accordingly, if the front and back plates are not precisely assembled into the panel, erroneous addressing discharge occurs in discharge cells placed at the boundary between upper and lower panels 11a and 11b.

That is, wrong addressing discharge is generated between at least one address electrode among the address electrodes A_{D1}˜A_{DN} of the upper panel 11a and the scan electrode Y_{M/2+1} of the upper panel 11b at the boundary of the upper and low panels 11a and 11b, bringing about deterioration of picture quality.

### SUMMARY OF THE INVENTION

It is, therefore, an object of the present invention is to provide an AC surface discharge PDP and a method for driving the PDP to prevent deterioration of picture quality of display images due to erroneous addressing discharge generated between the address electrode of the upper panel and the scan electrode of the lower panel in the PDP that drives its address electrodes, dividing them into upper and low parts.

To accomplish the object of the present invention, there is provided a method for driving an AC surface discharge PDP which includes a plurality of scan electrodes driven, being divided into upper and lower groups, a plurality of sustain electrodes respectively corresponding to the scan electrodes and being arranged on the same plane in parallel with the scan electrodes and a plurality of first and second address electrodes being divided into upper and lower parts and intersecting the scan electrodes and the sustain electrodes having predetermined spaces therebetween, the PDP having a discharge cell formed at an intersection where the scan electrodes and sustain electrodes intersect the first and second address electrodes, wherein, in the event of scanning the scan electrodes of the upper groups placed in the area where the first address electrodes are arranged and the scan electrodes of the lower groups located in the area where the second address electrodes are arranged, predetermined scanning pulses are sequentially applied to the scan electrodes of the upper and lower groups, respectively, and simultaneously, a predetermined image pulse is selectively applied to the first and second address electrodes with the same clock as the scanning pulses, the scanning pulse being applied to the lower scan electrodes in advance by at least one clock before the scanning pulse is applied to the upper scan electrodes.

To accomplish the object of the present invention, there is also provided an AC surface discharge PDP having a panel, a scan electrode driver, a sustain electrode driver and an address electrode driver which are connected to the panel, and a controller for controlling the drivers, wherein the panel includes a plurality of scan electrodes driven being divided into upper and lower groups, a plurality of sustain electrodes, and a plurality of first and second address electrodes arranged being divided into upper and lower parts, the address electrode driver is constructed of first and second address electrode driving units selectively providing predetermined image pulses to the first and second address electrode, respectively, when the upper and lower scan electrodes are scanned, and the controller controls the scan electrode driver and the first and second address electrode drivers so that scanning of the lower scan electrodes for the second address electrodes begins in advance by at least one clock before scanning of the upper scan electrode for the first address electrodes starts.

According to the aforementioned configuration, the picture quality of display image can be improved.

### BRIEF DESCRIPTION OF THE DRAWINGS

Further objects and advantages of the invention can be more fully understood from the following detailed description taken in conjunction with the accompanying drawings, in which:

FIG. 1 is a block diagram of a conventional AC surface discharge PDP;

FIG. 2 is a timing diagram for explaining a method of driving the conventional AC surface discharge PDP of FIG. 1;

FIG. 3 illustrates the configuration of a conventional AC surface discharge PDP whose address electrodes are divided into upper and low parts;

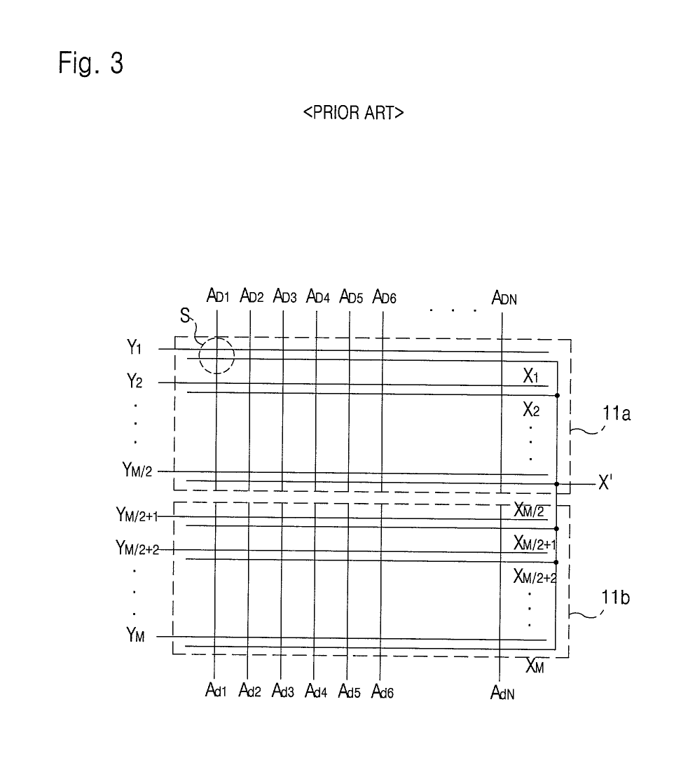

FIG. 4 is a block diagram of an AC surface discharge PDP according to an embodiment of the present invention;

FIG. 5 is a timing diagram for explaining a method of driving the AC surface discharge PDP of FIG. 4; and

FIG. 6 illustrates the intensity of discharge voltage required in the event of addressing discharge according to the distance between discharge cells.

### DETAILED DESCRIPTION OF THE PREFERRED EMBODIMENT

The present invention will now be described in connection with preferred embodiments with reference to the accompanying drawings.

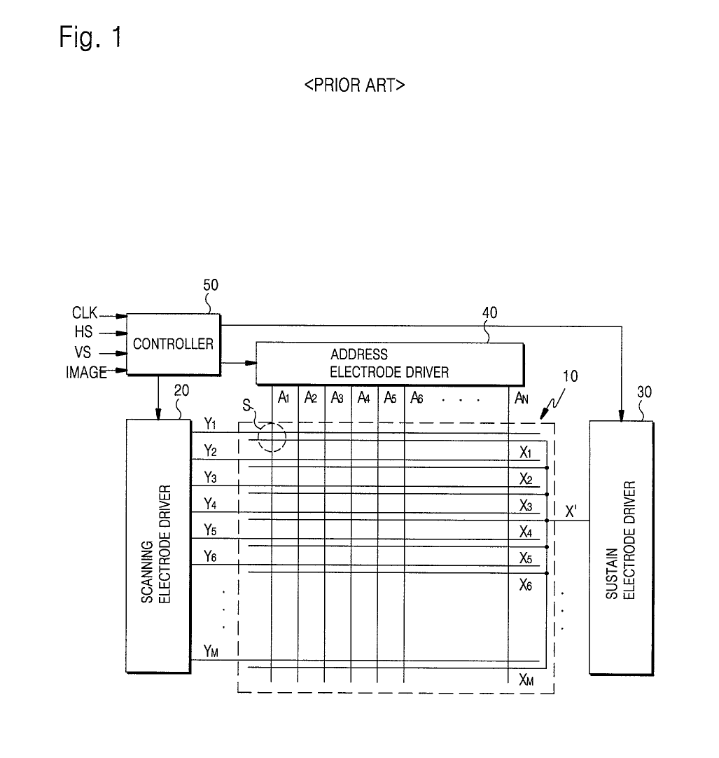

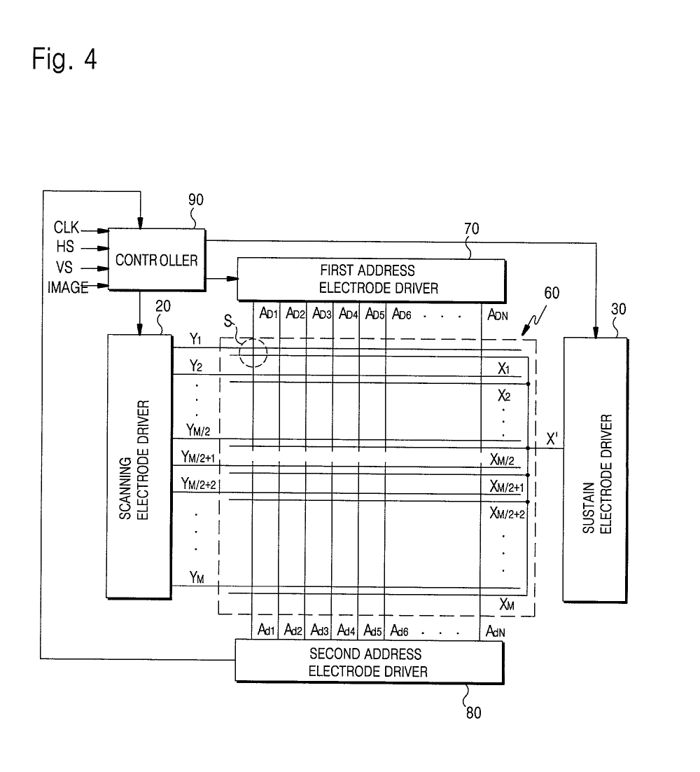

FIG. 4 is a block diagram of an AC surface discharge PDP according to an embodiment of the present invention. Throughout FIGS. 1 and 4, similar parts are designated by like reference numerals and explanations for them are omitted.

In FIG. 4, reference numeral 60 denotes the PDP which includes M scan electrodes Y₁˜Y_{M} being divided into upper and lower groups, M sustain electrodes X₁˜X_{M} respectively corresponding to and being arranged on the same plane in parallel with the scan electrodes, and first and second N address electrodes A_{D1}˜A_{DN} and Ad₁˜A_{dN} arranged being divided into upper and lower parts and intersecting the M scan electrodes Y₁˜Y_{M} and sustain electrodes X₁˜X_{M} having a predetermined space between them. The PDP further has a discharge cell S formed at an intersection where the scan electrodes Y₁˜Y_{M} and sustain electrodes X₁˜X_{M} intersect the first and second address electrodes A_{D1}˜A_{DN} and Ad₁˜A_{dN}.

Reference numeral 70 represents a first address electrode driver that has a plurality of output ports serially connected with the first address electrodes A_{D1}˜A_{DN} one to one and provides a predetermined driving pulse to the first address electrode A_{D1}˜A_{DN} to generate addressing discharge at the upper scan electrodes Y₁˜Y_{M/2} and corresponding discharge cells S. Reference numeral 80 denotes a second address electrode driver that has a plurality of output ports serially connected with the second address electrodes A_{d1}˜A_{dN} one to one and provides a predetermined driving pulse to the second address electrode A_{d1}˜A_{dN} to generate addressing discharge at the lower scan electrodes Y_{M/2+1}˜Y_{M} and corresponding discharge cells S.

Reference numeral 90 in FIG. 4 represents a controller that controls the operation of the scan electrode driver 20, sustain electrode driver 30, first and second address electrode drivers 70 and 80 to adjust output of a digital video signal to the panel 60, as the controller 50 of FIG. 1 does. The controller 90 controls the scan electrode driver 20, first and second electrode drivers 70 and 80 so that a scan starting point between the upper scan electrodes and the first address electrodes and a scan starting point between the lower scan electrodes and the second address electrodes have at least one clock time lag during the address period.

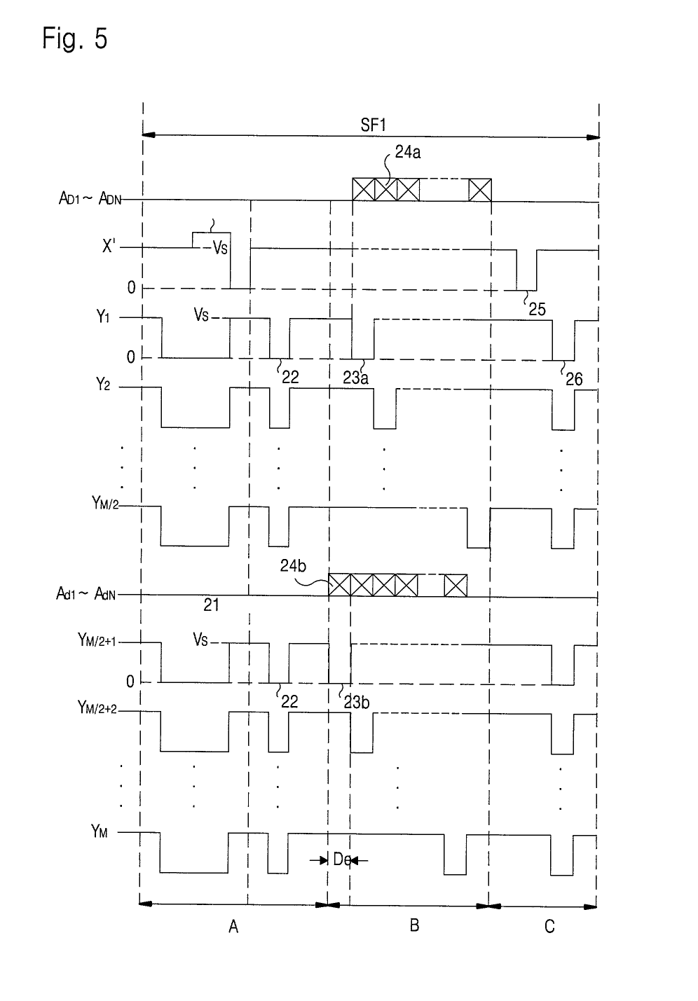

An embodiment of the present invention is described below in more detail with reference to FIG. 5. FIG. 5 is a timing diagram for explaining the method of driving the AC surface discharge PDP and its operation, which illustrates waveforms of driving voltages applied to the electrodes during one sub-field SF1 among one frame of a video signal.

One frame of a video signal is split into eight sub-fields when it expresses 256 gray scales, each sub-field being divided into the reset period A, address period B and sustain period C to be driven as described above. During the reset period A of each sub-field, the sustain electrode driver 30 applies a writing pulse 21 of above a discharge initiating voltage to all of the sustain electrodes X₁˜X_{M} simultaneously through the common sustain electrode X′ while the scan electrode driver 20 supplies 0V pulse to all of the scan electrodes Y₁˜Y_{M} as shown in FIG. 5, to thereby generate wall charges in the entire discharge cells S. In this case, positive wall charges are created in the scan electrodes Y₁˜Y_{M} while negative wall charges are generated in the sustain electrodes X₁˜X_{M}.

Thereafter, when a voltage Vs lower than the discharge initiating voltage is applied to all the scan electrodes Y₁˜Y_{M} and voltage of 0V is applied to the common sustain electrode X′, voltages of the wall charges created as above are added up to generate discharge between all of the scan electrodes Y₁˜Y_{M} and sustain electrodes X₁˜X_{M}, generating negative wall charges in the scan electrodes Y₁˜Y_{M} and positive wall charges in the sustain electrodes X₁˜X_{M}.

Subsequently, when the scan electrode driver 20 applies the erasing pulse 22 of 0V to both of the upper and lower scan electrodes Y₁˜Y_{M/2} and Y_{M/2+1}˜Y_{M} while the common sustain electrode X′ is being provided with the voltage Vs lower than the discharge initiating voltage by the sustain electrode driver 30, unnecessary wall charges in the entire discharge cells S are neutralized to be erased.

During the address period B in FIG. 5 for addressing digital video signals, scanning pulses 23a and 23b of 0V are respectively and sequentially applied to the upper scan electrodes Y₁˜Y_{M/2} intersecting the first address electrodes A_{D1}˜A_{DN} and the lower scan electrodes Y_{M/2+1 ˜Y}_{M} intersecting the second address electrodes A_{d1}˜A_{dN}, and simultaneously, addressing pulses 24a and 24b are selectively applied to the first and second address electrodes A_{D1}˜A_{DN} and A_{d1}˜A_{dN} through the first and second address drivers 70 and 80, respectively.

In FIG. 5, the scanning pulse 23a is applied to the upper scan electrodes Y₁˜Y_{M/2} in such a manner that it is sequentially supplied from the scan electrode Y₁ to the scan electrode Y_{M/2} and the addressing pulse 24a is selectively applied to the first address electrodes A_{D1}˜A_{DN} so that addressing discharge occurs in corresponding discharge cells S. In addition, the scanning pulse 23b is applied to the lower scan electrodes Y_{M/2+1}˜Y_{M} in such a manner that it is sequentially provided from the scan electrode Y_{M/2} to the scan electrode Y_{M} and the addressing pulse 24b is selectively applied to the second address electrodes A_{d1}˜A_{dN} to create addressing discharge in corresponding discharge cells S.

Here, as shown in FIG. 5, the scanning pulse 23a applied to the upper scan electrodes Y₁˜Y_{M/2} is delayed by at least one clock from the scanning pulse 23b applied to the lower scan electrodes A_{d1}˜A_{dN}, and the addressing pulse 24a supplied to the first address electrodes A_{D1}˜A_{DN} is delayed by the time delay from the addressing pulse 24b applied to the second address electrodes A_{d1}˜A_{dN}. In this case, scanning of the upper and lower scan electrodes Y₁˜Y_{M/2} and Y_{M/2+1}˜Y_{M} are sequentially performed in a manner that, after scanning the first scan electrode Y_{M/2+1} of the lower scan electrodes Y_{M/2+1}˜Y_{M}, the first scan electrode Y₁ of the upper scan electrodes Y₁˜Y_{M/2} and the second scan electrode Y_{M/2+2} of the lower scan electrodes Y_{M/2+1}˜Y_{M} are scanned and then the second scan electrode Y₂ of the upper scan electrodes Y₁˜Y_{M/2} and the third scan electrode Y_{M/2+3} of the lower scan electrodes Y_{M/2+1}˜Y_{M} are scanned.

Accordingly, the first scan electrode Y_{M/2+1} of the lower scan electrodes Y_{M/2+1}˜Y_{M} is scanned in advance by at least one clock, and then scanning of the upper and lower scan electrodes Y₂˜Y_{M/2} and Y_{M/2+1}˜Y_{M} are carried out so that erroneous addressing discharge is prevented from being created between the first scan electrode Y_{M/2+1} of the lower scan electrodes Y_{M/2+1}˜Y_{M} and the first address electrodes A_{D1}˜AY_{DN}.

That is, FIG. 5 shows an embodiment in which the scanning pulse 23a applied to the upper scan electrodes Y₁˜Y_{M/2} and the addressing pulse 24a applied to the first address electrodes A_{D1}˜A_{DN} are time-delayed by one clock De. Here, possibility of the generation of erroneous addressing discharge between the lower scan electrodes and the first address electrodes decreases as the distance between the discharge cells S increases.

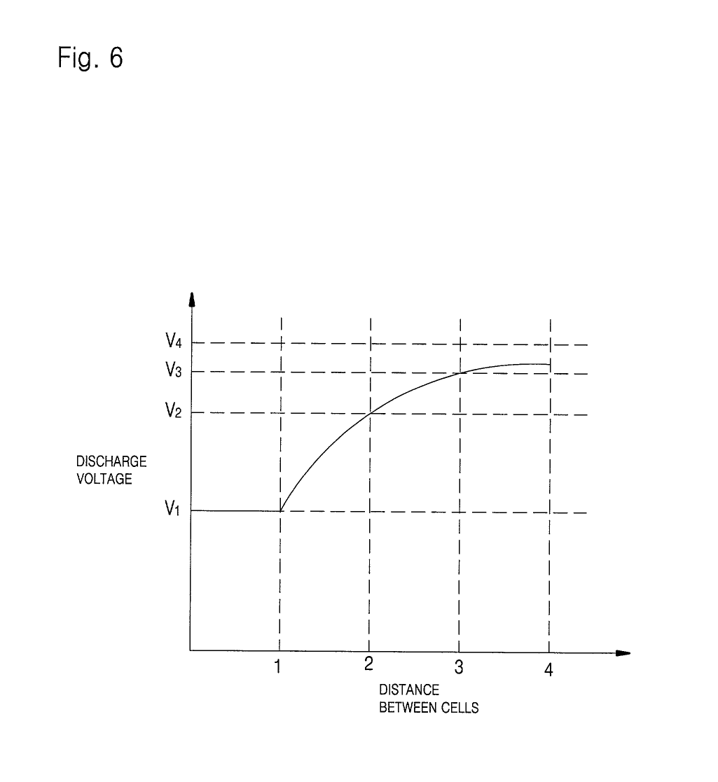

FIG. 6 illustrates intensities of discharge voltages V₁˜V₄ required for the addressing discharge in accordance with the distance between the discharge cells S. In FIG. 6, one unit of the distance between cells represents the distance between neighboring scan electrodes. V₁ in FIG. 6 indicates the voltage required for addressing discharge between discharge cells S adjacent to each other, which increases exponentially as the distance between cells increases, as shown in FIG. 6. Upon completion of addressing for the entire discharge cells S through the aforementioned procedure, the discharge cells are divided into ON and OFF states according as wall charges are generated therein.

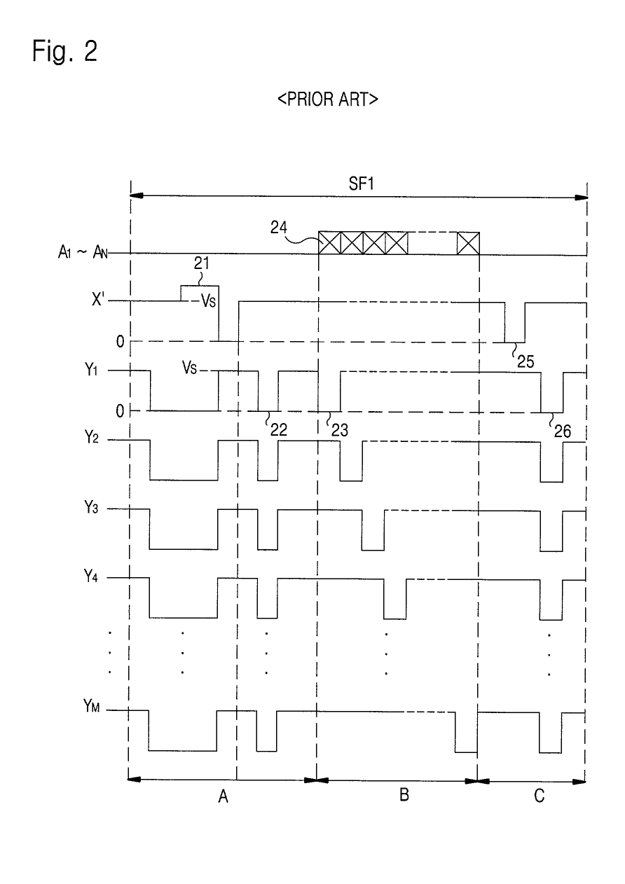

During the sustain period C in FIG. 5, as explained above with reference to FIG. 2, sustaining pulses 25 and 26 which alternate are continuously applied between the scan electrodes Y₁˜Y_{M} and sustain electrodes X₁˜X_{M}, to allow sustain discharge to be generated continuously in discharge cells in ON state. That is, when the scan electrode driver 20 applies the voltage Vs to all of the scan electrodes Y₁˜Y_{M} and the sustain electrode driver 30 provides 0V through the common sustain electrode X′, wall charges are added up in the discharge cells S in ON state during the address period B to cause sustain discharge. Thereafter, all of the scan electrodes Y₁˜Y_{M} are provided with 0V and the voltage Vs is applied through the common sustain electrode X′ to generate sustain discharge again. This operation is repeated during the sustain period C.

According to the above-described embodiment, therefore, in case where the address electrodes of the AC surface discharge PDP are divided into upper and lower parts and the split two parts of address electrodes are independently scanned during the address period, the lower scan electrodes are scanned in advance by at least one clock before the upper scan electrodes are scanned. This prevents distortion of displayed images and deterioration of the picture quality due to erroneous addressing discharge created between the address electrodes located in the upper panel and the first scan electrode of the lower panel.

Meantime, though the erasing pulse applied to the sustain electrodes, the scanning pulse applied to the scan electrodes and the sustaining pulse alternately supplied to the sustain electrodes and scan electrodes are 0V in FIG. 5, driving pulses with predetermined voltage levels having positive or negative polarities based on a voltage difference required for discharge operation between the electrodes can be used as the driving pulses applied to the sustain electrode, the scan electrodes and the address electrodes.

As described above, the present invention can prevent deterioration of the picture quality of displayed images caused by erroneous addressing discharge between the scan electrodes and the address electrodes located at the boundary of the address electrodes of upper and lower parts of the PDP.

What is claimed is:

1. A method for driving an AC surface discharge PDP which includes a plurality of scan electrodes driven, being divided into upper and lower groups, a plurality of sustain electrodes respectively corresponding to the scan electrodes and being arranged on the same plane in parallel with the scan electrodes and a plurality of first and second address electrodes being divided into upper and lower parts and intersecting the scan electrodes and the sustain electrodes having predetermined spaces therebetween, the PDP having a discharge cell formed at an intersection where the scan electrodes and sustain electrodes intersect the first and second address electrodes,
wherein, in the event of scanning the scan electrodes of the upper groups placed in the area where the first address electrodes are arranged and the scan electrodes of the lower groups located in the area where the second address electrodes are arranged, predetermined scanning pulses are sequentially applied to the scan electrodes of the upper and lower groups, respectively, and simultaneously, a predetermined image pulse is selectively applied to the first and second address electrodes with the same clock as the scanning pulses, the scanning pulse being applied to the lower scan electrodes in advance by at least one clock before the scanning pulse is applied to the upper scan electrodes.

2. An AC surface discharge PDP having a panel, a scan electrode driver, a sustain electrode driver and an address electrode driver which are connected to the panel, and a controller for controlling the drivers,
wherein the panel includes a plurality of scan electrodes driven being divided into upper and lower groups, a plurality of sustain electrodes, and a plurality of first and second address electrodes arranged being divided into upper and lower parts,
the address electrode driver is constructed of first and second address electrode driving units selectively providing predetermined image pulses to the first and second address electrode, respectively, when the upper and lower scan electrodes are scanned, and
the controller controls the scan electrode driver and the first and second address electrode drivers so that scanning of the lower scan electrodes for the second address electrodes begins in advance by at least one clock before scanning of the upper scan electrode for the first address electrodes starts.
